(19) United States
(12) Patent Application Publication
(10) Pub. No.: US 2026/0076506 A1
(43) Pub. Date: Mar. 19, 2026

(54) GRATED FOOD-HANDLING DEVICE AND COOKING UTENSILS FOR USE WITH COOKING SURFACE

(71) Applicant: Jacob Hostetler, Fredericksburg, OH (US)

(72) Inventor: Jacob Hostetler, Fredericksburg, OH (US)

(21) Appl. No.: 19/331,665

(22) Filed: Sep. 17, 2025

Related U.S. Application Data
(60) Provisional application No. 63/695,670, filed on Sep. 17, 2024.

(51) Int. Cl. A47J 37/04; A47J 37/07

(52) U.S. Cl. CPC A47J 37/049; A47J 37/0786; A47J 2037/0795

(57) ABSTRACT

A grated food-handling device including first and second grated assemblies each including a support frame having a support frame, a handle portion disposed at one end of the support frame, a connecting portion disposed at an opposite end of the support frame, and a planar grate disposed on the support frame, wherein the first grated assembly and the second grated assembly are separably and movably connected to each other, and where when the grated food-handling device is in a closed configuration a cooking volume is defined by the space between said first planar grate and said second planar grate. Further, a cooking utensil including a planar base, a plurality of sidewalls disposed along a perimeter of the planar base, at least one handle slot formed within at least one of the plurality of sidewalls, and a removable handle comprising a proximal end, a handle portion, and a distal end including one or more engaging tines and a stability member is provided for use with grated food-handling devices.

### CROSS-REFERENCE TO RELATED APPLICATIONS

The present application claims priority to U.S. Provisional Patent Application Ser. No. 63/695,670 filed Sep. 17, 2024, the entirety of which is incorporated herein by reference.

### FIELD OF THE INVENTION

The present invention generally relates to cooking or culinary implements and more specifically to accessories which provide for the containment of food for cooking on an outdoor cooking surface.

### BACKGROUND OF THE INVENTION

It is well known that food can be prepared and cooked over cooking surfaces that provide heat. Typically, food is contained in pots, pans, baskets, baking sheets, and other cookware. When using outdoor cooking surfaces, such as those fueled by combustible sources such as natural gas, propane, charcoal, wood, wood pellets, and the like, grated surfaces are used to hold food over a heat source or serve as the cooking surface. While cooking food on such grated surfaces, there is a need to flip, or turnover, the food as it cooks such that the heat is applied more evenly to the food. Common problems encountered when performing such flipping or turning over relate to food sticking to the cooking surface or grate, food falling through the spaces in the grate, and continuously turning food when cooking large quantities. Attempts to address these problems include the use of non-stick grates, grates with smaller spacing, and complex rotisserie style systems that may not be suitable for all types of food. Thus, there is a need for food handling device that securely contains food and allows for ease of evenly cooking the food through flipping and turning.

The present invention provides an apparatus and methods that will serve the art by providing a means to improve the outdoor cooking experience.

### SUMMARY OF THE INVENTION

An embodiment of the present invention provides a grated food-handling device including a first grated assembly including a first integrated handle and a second grated assembly including a second integrated handle, wherein a cooking volume is defined as the space between said first grated assembly and said second grated assembly, and wherein said first grated assembly and said second grated assembly are movably connected to each other to provide access to the cooking volume.

Another embodiment of the present invention provides a cooking utensil suitable for use, alone or in combination with any embodiment described above, including a

### BRIEF DESCRIPTION OF THE DRAWINGS

For a more complete understanding of the features and advantages of the present invention, reference is now made to the detailed description of the invention along with the accompanying figures in which:

FIG. 1 is a side-view of an embodiment of the present invention in a closed state;

FIG. 2 is a side-view of an embodiment of the present invention in an open state;

FIG. 3 is a side-view of an embodiment of the present invention in a further opened state;

FIG. 4 is side-view of an embodiment of the present invention in a closed and carried state;

FIG. 5 is a close-up side-view of the handle of an embodiment of the present invention in a closed state;

FIG. 6 is a close-up side-view of the handle of an embodiment of the present invention in a closed state;

FIG. 7 is a close-up side-view of the handle of an embodiment of the present invention in a closed state;

FIG. 8 is a close-up side-view of the hinge of an embodiment of the present invention in a closed state;

FIG. 9 is a close-up side-view of the hinge of an embodiment of the present invention in a closed state;

FIG. 10 is a close-up side-view of the hinge of an embodiment of the present invention in a partially opened state;

FIG. 11 is a close-up side-view of the hinge of an embodiment of the present invention in a closed state;

FIG. 12 is a close-up side-view of the hinge of an embodiment of the present invention in a closed state;

FIG. 13 is a close-up side-view of the hinge of an embodiment of the present invention in a closed state;

FIG. 14 is a close-up side-view of the hinge of an embodiment of the present invention in a closed state;

FIG. 15 is a three-quarters view of the hinge side of an embodiment of the present invention in a closed state;

FIG. 16 is a close-up rear-view of the hinge of an embodiment of the present invention in a closed state;

FIG. 17 is a close-up rear-view of the hinge of an embodiment of the present invention in a closed state;

FIG. 18 is a close-up rear-view of the hinge of an embodiment of the present invention in a closed state;

FIG. 19 is a close-up rear-view of the hinge of an embodiment of the present invention in a closed state;

FIG. 20 is a close-up rear-view of the hinge of an embodiment of the present invention in a closed state;

FIG. 21 is a close-up rear-view of the hinge of an embodiment of the present invention in a closed state;

FIG. 22 is a close-up rear-view of the hinge of an embodiment of the present invention in a closed state;

FIG. 23 is a close-up top-down-view of the hinge of an embodiment of the present invention in a closed state;

FIG. 24 is a close-up rear-view of the hinge of an embodiment of the present invention in a fully opened state;

FIG. 25 is a close-up rear-view of the hinge of an embodiment of the present invention in a closed state;

FIG. 26 is a close-up rear-view of the hinge of an embodiment of the present invention in an opened state;

FIG. 27 is a close-up rear-view of the hinge of an embodiment of the present invention in an opened state;

FIG. 28 is a close-up rear-and side-view of the hinge of an embodiment of the present invention in a partially-opened state;

FIG. 29 is a close-up rear-and side-view of the hinge of an embodiment of the present invention in a partially-opened state;

FIG. 30 is a close-up top-and rear-view of the hinge of an embodiment of the present invention in a closed state;

FIG. 31 is a close-up side-and rear-view of the hinge of an embodiment of the present invention in a closed state;

FIG. 32 is a close-up rear-view of the hinge of an embodiment of the present invention in a closed state;

FIG. 33 is a close-up rear-view of the hinge of an embodiment of the present invention in an open and repositioned state;

FIG. 34 is a close-up rear-view of the hinge of an embodiment of the present invention in a closed state;

FIG. 35 is a close-up rear-view of the hinge of an embodiment of the present invention in a closed state;

FIG. 36 is a close-up rear-view of the hinge of an embodiment of the present invention in a closed state; and

FIG. 37 is a close-up rear-view of the hinge of an embodiment of the present invention in a closed state;

FIG. 38 is a close-up rear-view of the hinge of an embodiment of the present invention in a closed state;

FIG. 39 is a side view of an embodiment of a cooking utensil within an embodiment of the present invention in an open state;

FIG. 40 is a side view of an embodiment of a cooking utensil within an embodiment of the present invention in a closed state;

FIG. 41 is a close-up top view of an embodiment of a cooking utensil of the present invention;

FIG. 42 is a close-up side view of an embodiment of a removable handle of the present invention;

FIG. 43 is a close-up side view of an embodiment of a removable handle of the present invention;

FIG. 44 is a close-up top-down view of an embodiment of a removable handle and cooking utensil of the present invention;

FIG. 45 is a close-up top-down view of an embodiment of a removable handle and cooking utensil of the present invention;

FIG. 46 is a close-up top-down view of an embodiment of a removable handle and cooking utensil of the present invention;

FIG. 47 is a top-down view of an embodiment of a removable handle and cooking utensil of the present invention; and

FIG. 48 is a close-up side view of an embodiment of a removable handle and cooking utensil of the present invention.

### DETAILED DESCRIPTION OF ILLUSTRATIVE EMBODIMENTS

The present invention provides grated food-handling devices and cooking utensils suitable for use with a variety of cooking surfaces. In general, it is to be understood that a cooking surface is simply a source of heat suitable for cooking food. Exemplary sources of heat suitable for use as a cooking surface include ranges including gas and electrical, barbecue grills including natural gas, propane, charcoal, wood, wood pellet, and the like as fuel, flat top grilles, open fire, and ovens. Further, embodiments of the present invention may be used in conjunction with other cooking or culinary implements.

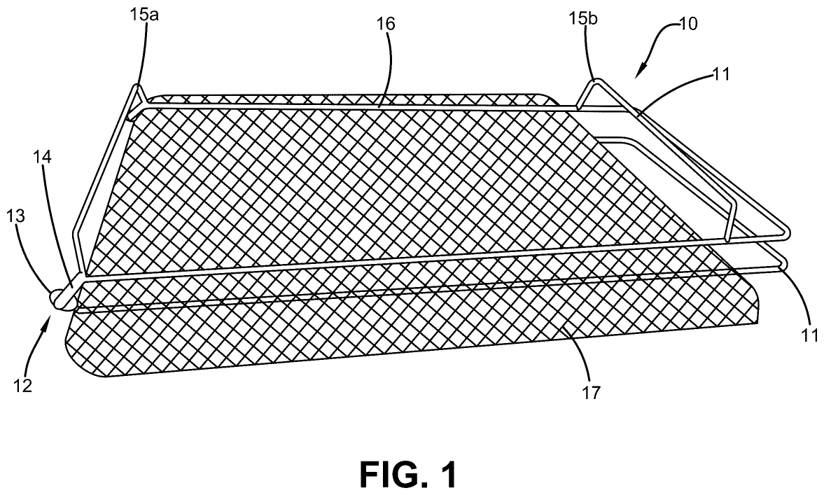

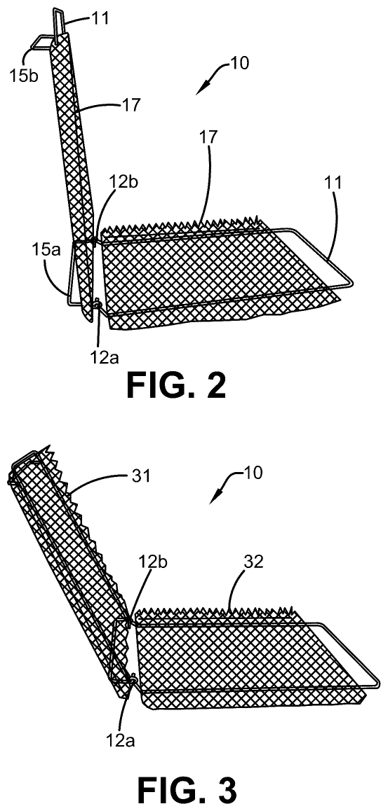

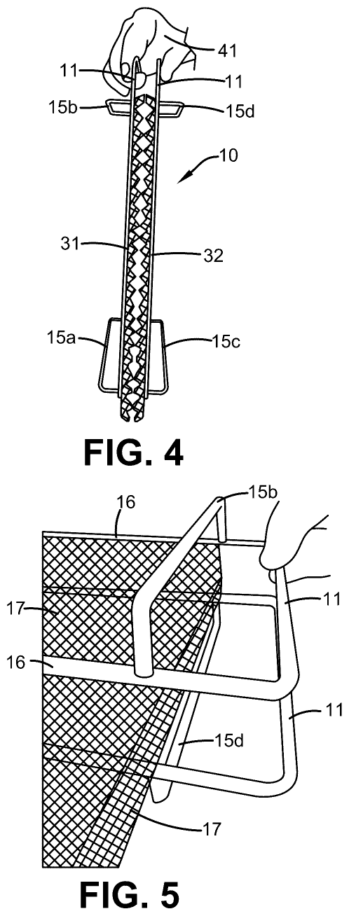

Referring now to FIGS. 1 through 4 an embodiment of a grated food-handling device is shown, generally indicated by the numeral 10. As shown in FIGS. 1 through 4, grated food-handling device 10 may be operated in a variety of configurations including a closed configuration (FIGS. 1 and 4) and a plurality of open configurations (FIGS. 2 and 3). Grated food-handling device 10 generally includes first grated assembly 31 and second grated assembly 32 that are connected together. In particular, first grated assembly 31 and second grated assembly 32 include support frame 16 which includes handle portions 11 located at a first end of first grated assembly 31 and second grated assembly 32, connecting portions 12a and 12b, which may also be referred to as hinges (collectively, connection portions 12 and hinges 12) each including hinge component 13, which may be referred to as female hinge component 13, and hinge component 14, which may be referred to as male hinge component 14, standoff portions 15a, 15b, 15c and 15d (collectively, standoff portions 15, and planar grates 17 disposed on grate support portions 16.

As best shown in FIG. 3, grated food-handling device 10 includes first grated assembly 31 and second grated assembly 32, joined together at connecting portions 12a and 12b. Connecting portions 12 allow for opening and closing of grated food-handling device 10 between the closed configuration and plurality of open configurations in order to facilitate the addition or removal of food to a cooking volume defined as the space between grate 17 of first grated assembly 31 and grate 17 of second grated assembly 32. During an opening operation a user lifts handle portion 11 of first grated assembly 31 to access the cooking volume. During a closing operation a user pulls handle portion 11 of first grated assembly 31 to contain the food within the cooking volume. As shown in FIG. 4, when grated food-handling device 10 is closed, hand 41 is able to grip both handle portions 11 of grated food-handling device 10. Advantageously, a user is able to single-handedly manipulate grated food-handling device 10 such as carrying, turning over or flipping, or otherwise move grated food-handling device 10 while containing any food within the cooking volume of grated food-handling device 10. Further, handle portions 11 of grated food-handling device 10 are shown extending past grates 17. Such an arrangement advantageously allows for grated food-handling device 10 to be placed over a heat source while providing for handle portions 11 to not be exposed directly to the heat source, allowing for a user to not be burned while touching handle portions 11 during use.

Embodiments of the present invention may be sized according to type of cooking surface or heat source the invention is intended to be used with. For example, charcoal grills have a round cooking surface that is 22 inches in diameter. Additional examples include 3-burner gas grills which commonly feature 400-500 square inches of cooking area at a variety of depths and widths. Accordingly, embodiments of the present invention include a variety of shapes including generally rectangular, circular, or other common shapes.

In some embodiments grated food-handling device includes a cooking volume defined by a cooking area and internal height between the first grated assembly and the second grated assembly. In these and other embodiments, grated food-handling device has a cooking area of 50 square inches or greater. In other embodiments, 75 square inches or greater. In other embodiments, 100 square inches or greater. In other embodiments, 150 square inches or greater. In other embodiments, 200 square inches or greater. In other embodiments, 250 square inches or greater. In these and other embodiments, grated food-handling device has an internal height of a half-inch or greater. In other embodiments, 1 inch or greater. In other embodiments, 2 inches or greater. In other embodiments, 3 inches or greater. In other embodiments, 4 inches or greater. In other embodiments, 5 inches or greater. In other embodiments, 6 inches or greater.

As discussed above, the arrangement of the planar grates serves to define the cooking volume for embodiments of the present invention. As shown in FIGS. 1-4, planar grates 17 are generally planar each with first and second major surfaces. Further, planar grates 17 are supported by planar grate support portions 16 which are part of handles 11 and hinges 12. Planar grates 17 include a hinge side and a handle side defined as the sides closest to hinges 12 and handles 11, respectively. Longitudinal sides serve to define the remaining sides of planar grates 17. The hinge side, handle side, and longitudinal sides of planar grates used in the present invention may be configured to be non-planar in order to provide improved containment for the food included in the cooking volume. For example, the hinge side, handle side, and longitudinal sides of planar grates may be bent or otherwise raised to thereby form part of and enclose the cooking volume. In these and other embodiments, a variety of bend angles may be used so long as food is securely contained within the cooking volume of the planar grated food-handling device.

Embodiments of grated food-handling devices according to the present invention may include a variety of materials as cooking grates or planar grates. Suitable grate materials include, without limitation, stainless steel, cast iron, cast stainless steel, porcelain coated steel, and others known in the art.

Embodiments of grated food-handling devices according to the present invention may include a variety of grate constructions. Grates suitable for use according to the present invention may include rod grates, cast grates, patterned grates including hexagonal and diamond, and others known in the art. As shown in FIG. 1, grate 17 is diamond patterned. Different grate constructions and geometries may be selected according to the type of heat properties, food to be cooked, ease of cleaning, weight, and ease of maintenance.

According one or more embodiments of the present invention the handle portion of a grated assembly is integrally formed as part of said assembly. In particular embodiments, the handle portion is part of a unitary support frame connected to and providing support to the grate along a longitudinal direction and includes a connecting portion include components for hinges. In these and other embodiments, standoffs may be connected or constructed as part of the handle portion. In these and other embodiments, the

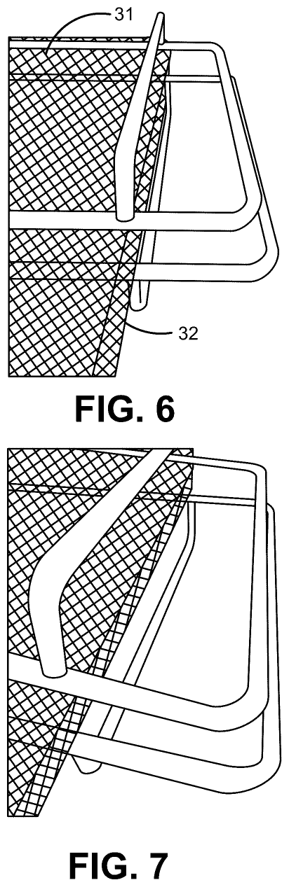

As previously discussed and as shown in FIGS. 1-7, handle portions 11 extend beyond planar grates 17. During use, this configuration allows for the handle portions 11 to be less exposed or not exposed to the heat provided by the cooking surface, which allows for a user to grab the handle portions to move, flip or turnover, or add food to or remove food from grated food-handling device 10, without the need for protection from heat. In embodiments of the present invention including increased internal heights to provide more cooking volume, the handle portions of the first and second grated assemblies may be lengthened or bent to ensure security of the food, while providing a comfortable grip for the user.

Materials suitable for use as handle portions according to one or more embodiments of the present invention must be able to support the grates and heated cooking conditions. As such, the handle portions may be constructed from the same material as discussed above with respect to grates.

According to one or more embodiments of the present invention, the support frame of a grated assembly may further include standoff elements or standoff portions, which may also be called standoffs. Standoffs provide a means for which the grated food-handling device can be placed on a cooking surface. In such embodiments, standoffs create a minimum distance from which the food will be exposed to heat from the cooking surface. Standoffs may increase the number of cooking surfaces where the grated food-handling device is suitable for use, as well as increasing the stability of the grated food-handling device during use. Further, standoffs may increase the number of suitable heat sources as for example coals may placed directly underneath the grated food-handling device without the food contained therein coming into direct contact with the coals.

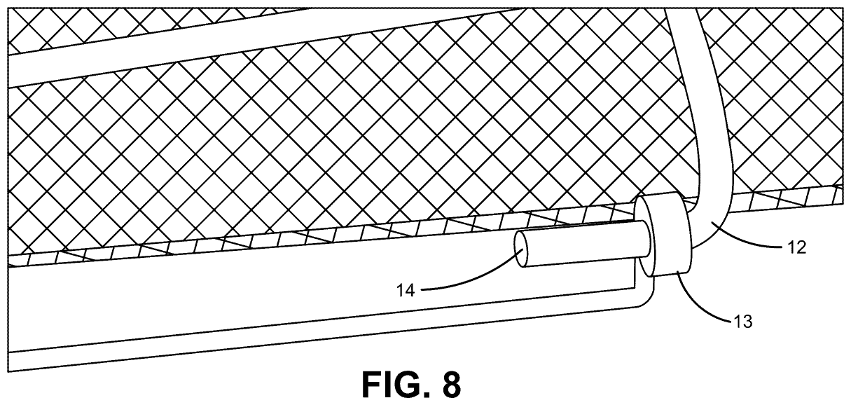

As shown in FIGS. 1-4 and 8-10, grated food-handling device 10 includes connection portions 12. Connecting portions 12 each include first connecting portion 13 and second connecting portion 14. According to this embodiment, first grated assembly 31 includes first connecting portion 14 and second grated assembly 32 includes second connecting portion 13. First connecting portion 14 is formed as part of handle 11. Second connecting portion 13 includes an eyelet and is formed as an integral part of support frame. Prior to use of grated food-handling device 10, first connecting portion 14 is placed through second connecting portion to movably and releasably attach first grated assembly 31 to second grated assembly 32. This arrangement advantageously streamlines manufacture and operation of grated food-handling device 10.

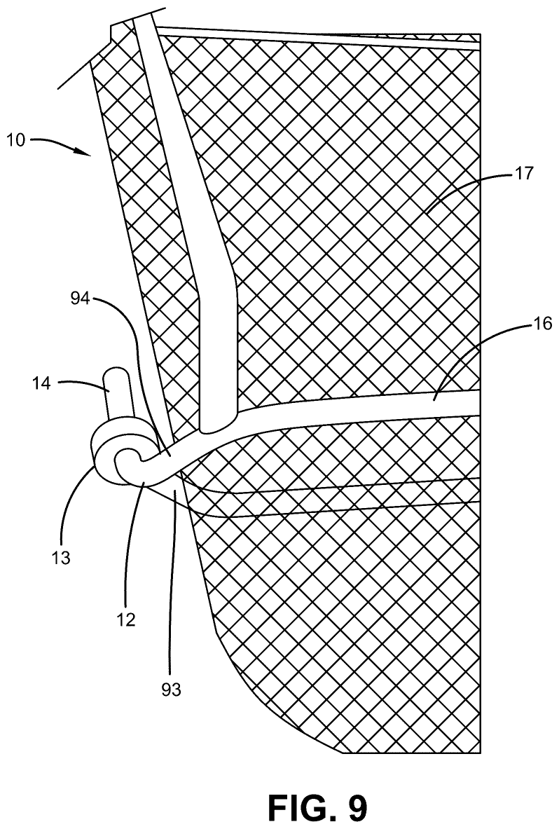

As shown specifically in FIG. 9, first connecting portion 13 is attached to support frame 16 via arm 93. Likewise, second connecting portion 14 is attached to support frame 16 via arm 94. The length and angle of arms 93 and 94 relative to support frame 16 may be adjusted to accommodate differing cooking volumes. For example, in embodiments where the cooking area remains constant, but the internal height of the cooking volume differs, the arms connected to the first and second connecting portions may be lengthened for increased internal heights and shortened for decreased internal heights. Likewise, the angle at which the arms are formed may be adjusted according to the shape of the hinge side of the grates and the cooking volume. By adjusting the length of the arms, the functioning of the hinges can be maintained to ensure containment of the food while using the grated food-handling device.

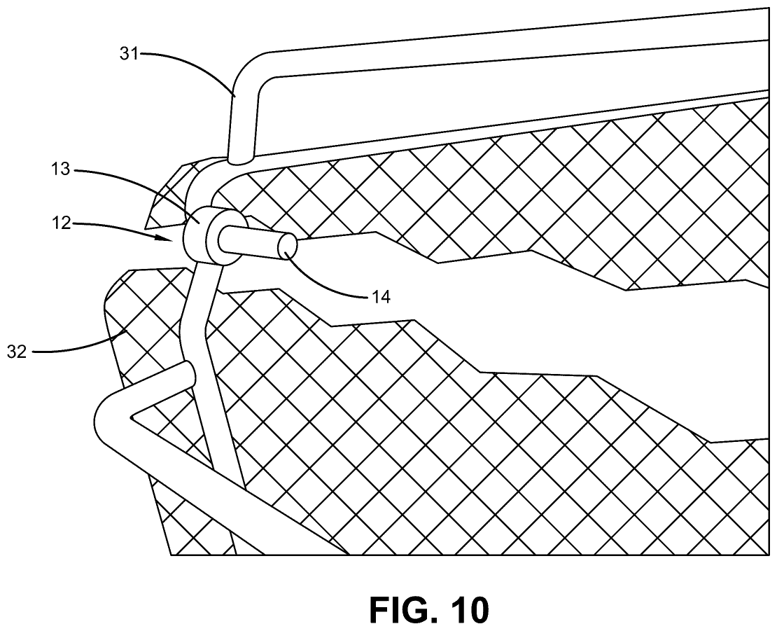

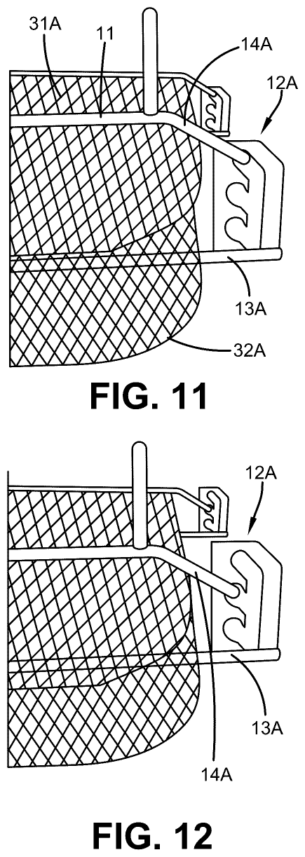

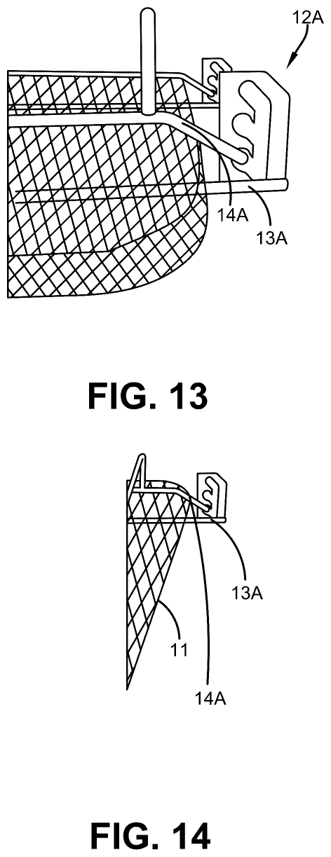

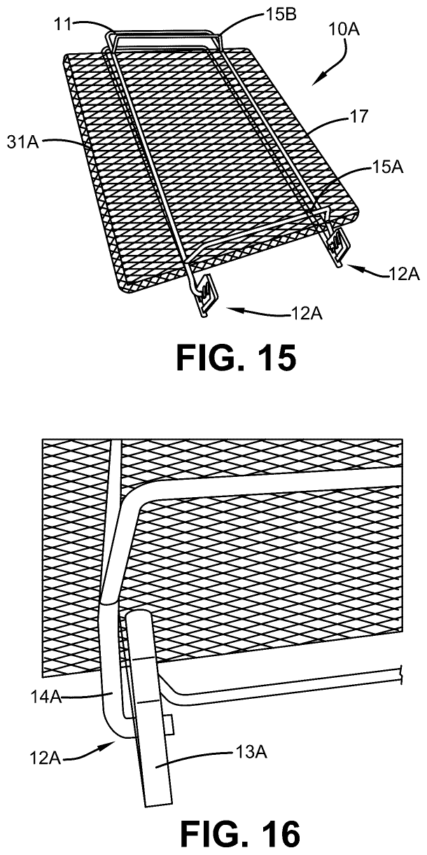

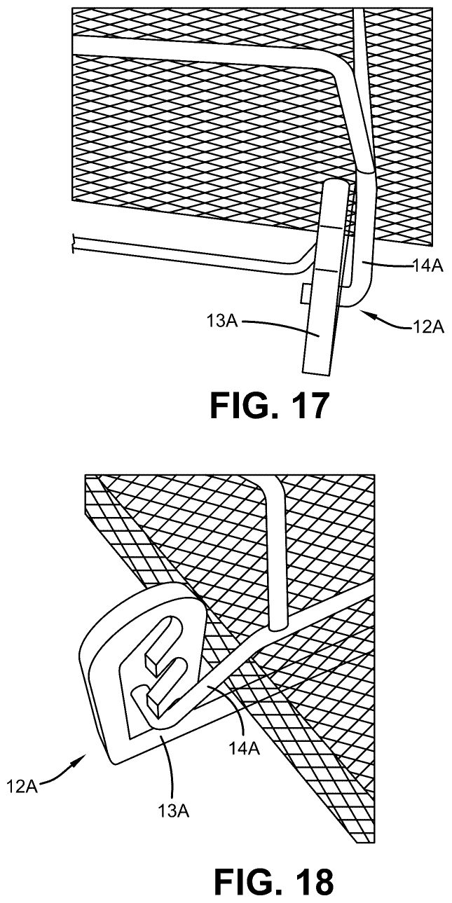

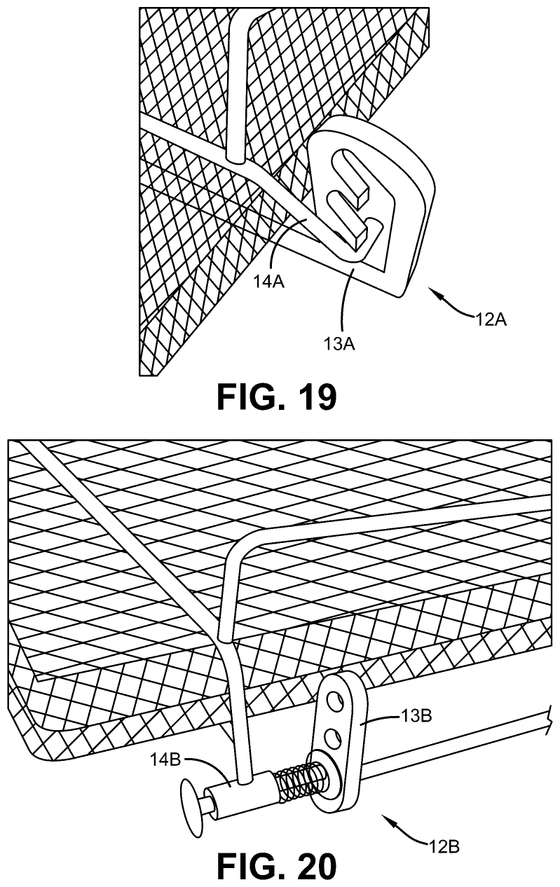

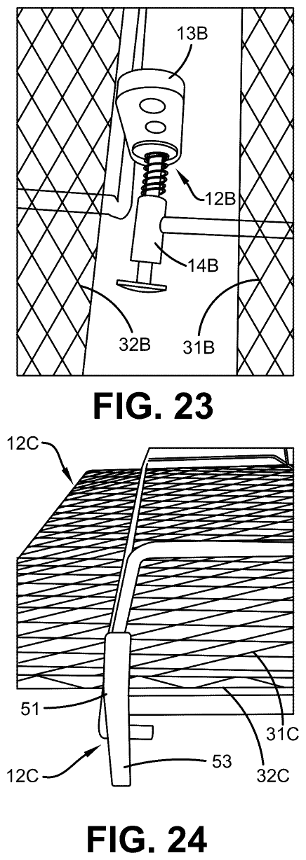

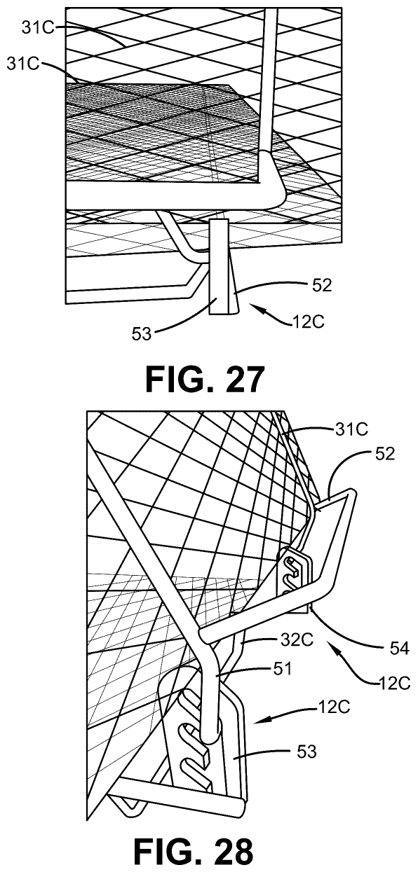

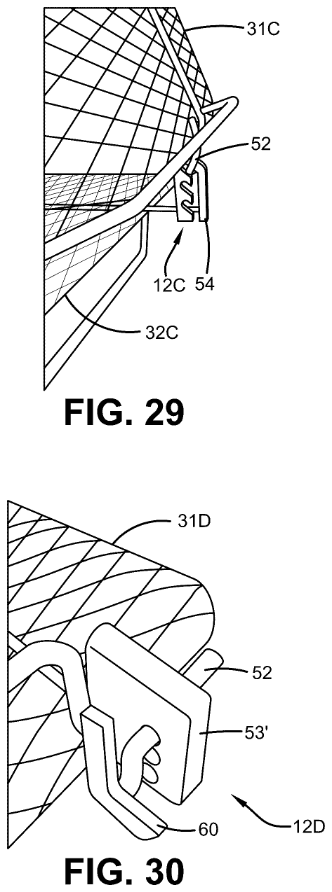

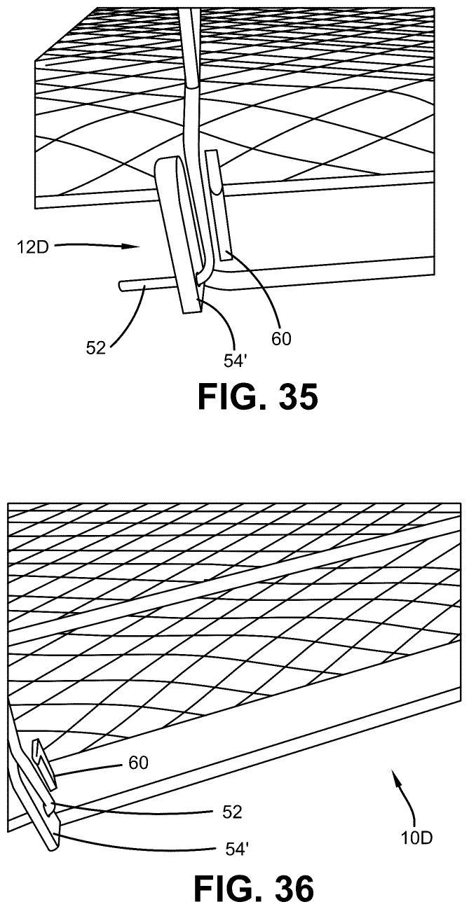

Further embodiments of the present invention are shown in FIGS. 11-38. In FIGS. 11-38, additional embodiments of connecting portions or hinges suitable for use with grated food-handling devices according to the present invention are shown. In these and other embodiments, the type of hinge selected can increase the utility of the grated food-handling device by providing for an adjustable cooking volume by controlling the internal height of the cooking area. Further, in these and other embodiments it is understood that grated food-handling device comprises a first grated assembly and a second grated assembly as in any embodiment, above, that are substantially identical apart from the first and second connecting portions which may be different to accommodate different modes of joining the first grated assembly and the second grated assembly. Advantageously, the connecting portions are user adjustable, and in some embodiments are adjustable without the need for tools.

As shown in FIGS. 11-19, grated food-handling device 10A includes two connecting portions joining first grated assembly 31A and second grated assembly 32A. Both connecting portions include slotted eyelet hinges 12A. Slotted eyelet hinges 12A each include hinge component 13A and hinge component 14A. Hinge component 14A may be referred to as an engagement member for engaging hinge component 13A which may be referred to as a hinge body. According to this embodiment, first grated assembly 31A includes hinge component 14A and second grated assembly 32A includes hinge component 13A. Hinge component 14A is formed as part of support frame 16. Hinge component 13A includes three slots to thereby provide adjustments in the internal height of the cooking volume. FIGS. 11-13 show grated food-handling device 10A in three different height configurations including a highest, intermediate, and lowest configuration respectively. First grated assembly 31A and second grated assembly 32A may be separated. The metal wires that form the hinges and handles of the grated assemblies may be a single metal wire with appropriately formed bends. The slots of the first hinge component may be welded to the wire as an integral assembly.

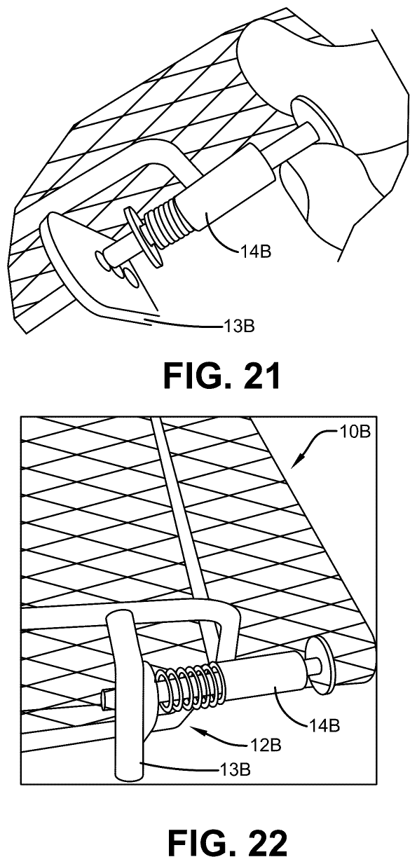

As shown in FIGS. 20-23, grated food-handling device 10B includes adjustable hinges 12B. Adjustable hinges 12B each include hinge component 13B and hinge component 14B. According to this embodiment, first grated assembly 31B includes hinge component 14B and second grated assembly 32B includes hinge component 13B. Hinge component 14B is attached to an end of the support frame. Hinge component 13B includes three eyelets or holes formed in a hinge body providing for adjustments in the internal height of the cooking volume. Other embodiments may include additional height adjustment holes. Hinge component 14B compromises a spring loaded pin where when the head of the pin is retracted, the spring is compressed, and the hinge component 14B may be placed in a different hole of hinge component 13B. FIG. 21 shows the pin being retracted so that the hinge may be adjusted to a different configuration. In FIG. 21, the spring is compressed while the user applies force to the pin head to disengage from the hole of the hinge body that is part of hinge component 13B.

In other embodiments, the hinge may include a threaded component attached to a first grated assembly that is configured to be placed through a hole or eyelet component attached to a second grated assembly where a threaded securing means engages the threaded component. In some embodiments, the threaded component may comprise a removable screw that engages a threaded receptacle after passing through a hole in the hinge component. In other embodiments, the threaded component may comprise a threaded screw that is secured to hinge using a nut. In these and other embodiments, the nuts and the screws may include finger engageable tabs to allow for tool-free operation.

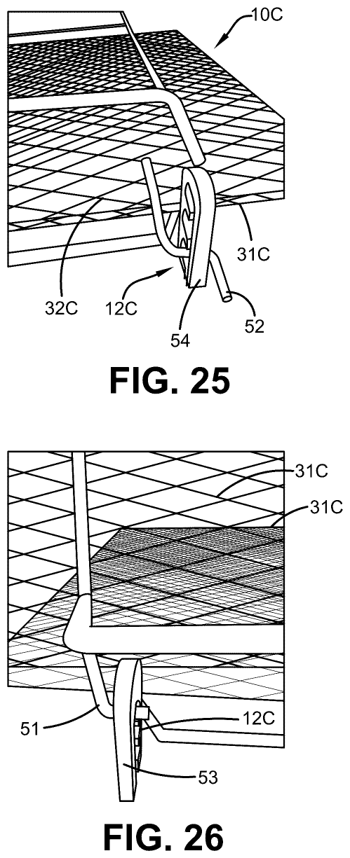

As shown in FIGS. 24-29, grated food-handling device 10C includes slotted hinges 12C. Slotted hinges 12C include rod portions 51, 52, which may be referred to as engagement members 51, 52, attached to first grated assembly 31C and slotted portions 53, 54, which may be referred to as hinge bodies 53, 54, attached to second grated assembly 32C. As shown in FIGS. 24 and 25, rod portions 51 and 52 have different geometries. Rod portion 51 includes a simple bend to engage slotted portion 53 to form the hinge. Rod portion 52 features an additional length and a substantially perpendicular bend to engage slotted portion 54 to form the hinge. As shown in FIGS. 26-29, grated food-handling device 10C may be opened by lifting first grated assembly 31C, where rotation occurs at slotted hinges 12C. As a result of the shape of rod portion 52, the slotted hinge 12C is securely positioned in one of the slotted portions. Further, first grated assembly 31C may be separated from second grated assembly 32C when first grated assembly 31C is substantially perpendicular to second grated assembly 32C such that rod portion 52 may be removed from slotted portion 54. Separation is further enabled as a result of rod portions 51 and 52 having their ends oriented in the same direction such that each rod portion engages slotted portions 53 and 54 from the same respective side.

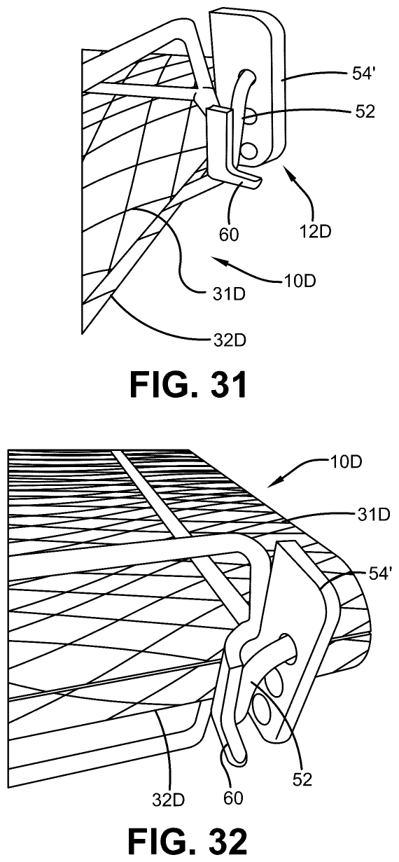

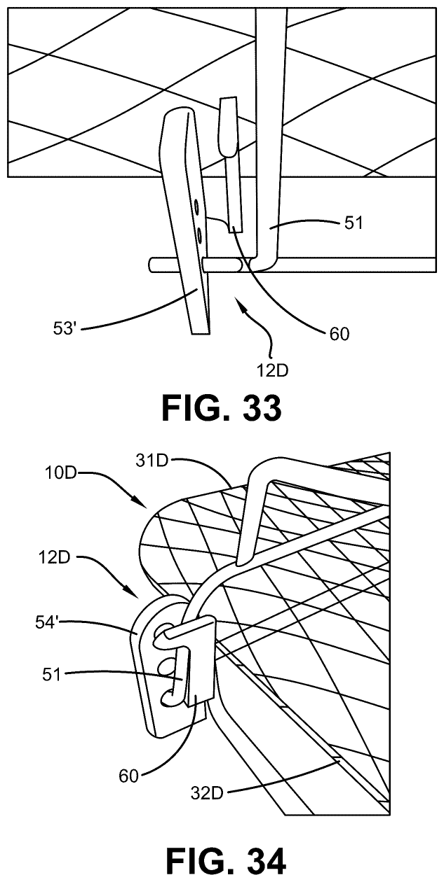

As shown in FIGS. 30-36, grated food-handling device 10D includes slotted hinges 12D. Slotted hinges 12D include rod portions 51, 52 attached to first grated assembly 31D and slotted portions 53′, 54′ attached to second grated assembly 32D. As shown in FIGS. 24 and 25, rod portions 51 and 52 have different geometries. Rod portion 51 includes a simple bend to engage slotted portion 53′ to form the hinge. Rod portion 52 features an additional length and a substantially perpendicular bend to engaged slotted portion 54′ to form the hinge. Slotted portions 53′ and 54′ include guard tabs 60, which prevent rod portions 51 and 52 from disengaging with slotted portions 53′ and 54′ during operation of grated food-handling device 10D. As shown in FIGS. 31-36, lateral movement of first grated assembly 31D relative to second grated assembly 32D is prevented while grated food-handling device 10D is closed. As a result of the shape of rod portion 52, the slotted hinge 12D is securely positioned in one of the slotted portions. Further, first grated assembly 31D may be separated from second grated assembly 32D when first grated assembly 31D is substantially perpendicular to second grated assembly 32D such that rod portion 52 may be removed from slotted portion 54′ as the rod portions will no longer be secured by guard tabs 60. An example of such separation is shown in FIG. 33, where rod portion 51 is able to bypass guard tab 60 and slide into a position of slot portion 53′.

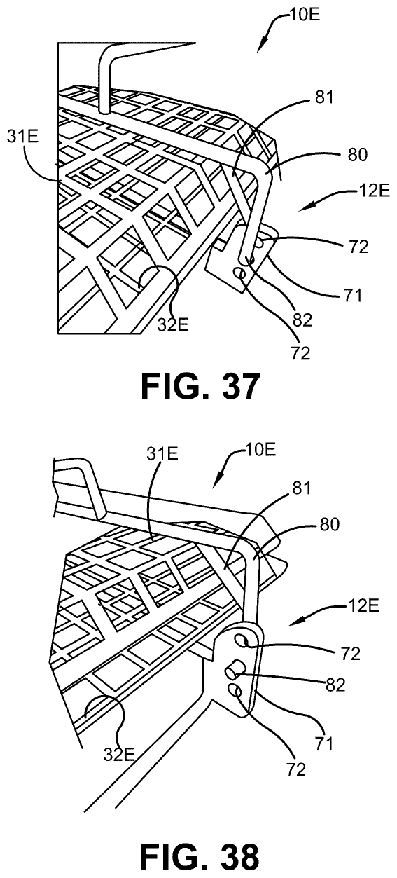

As shown in FIGS. 37-38, grated food-handling device 10E includes hinges 12E. Hinges 12E include female extension 71, which may be referred to as hinge body 71, attached to second grated assembly 32E. Female extension 71 includes holes 72. Hinges 12E further include rod portion 80, which may be referred to as engagement member 80, extending from first grated assembly 31E with brace member 81 and pivot end 82. Holes 72 of female extension 71 are configured to receive pivot end 82 of rod portion 80 to thereby connect first grated assembly 31E to second grated assembly 32E. Prior to use of grated food-handling device 10E, first grated assembly 31E and second grated assembly 32E may be joined by forcing pivot ends 82 outward to be received by any of holes 72 to adjust the cooking volume of grated food-handling device 10E and thereby join first grated assembly 31E and second grated assembly 32E together. The cooking volume of grated food-handling device 10E may be easily changed by forcing pivot ends 82 outward and being received by any of the other holes 72. Brace member 81 provides stability to rod portion 80 such that pivot ends 82 durably remain aligned with female extension 71 during use of grated food-handling device 10E. This arrangement advantageously streamlines manufacture and operation of grated food-handling device 10E. Braces and similar rod portions may be incorporated in other hinges described above. The ability to temporarily bend the rod portion to reconfigure the size of the cooking volume or to separate the first and second grated assemblies from one another is maintained by the use of one or more braces on the rod portion. Rod portions used for embodiments of the present invention provide spring force to maintain solid connection between the first grated assembly and the second grated assembly.

Practice of the present invention is in no way limited to the hinges as shown in the drawings. Other hinge assemblies known in the art may be employed so long as the grate of each grate assembly at the hinge end are able to remain proximate to each other during use grated food-handling devices according to the present invention. Such hinge couplings of each grate assembly may include any one of a number of hinge couplings known in the art.

### Cooking Insert with Removable Handle

Grated food-handling devices according to the present invention may further include additional cooking utensils as part of a grated food-handling assembly. Embodiments of the present invention including additional cooking utensils may include pans, lids, fine mesh surfaces, griddles, and the like. Such utensils are generally described as a pan and include a substantially planar base and sidewalls that effectively conduct heat while preventing food from falling through. The substantially planar base and side walls may be solid and flat surfaces, or perforated metal surfaces. Pans according to the present invention include a removable handle that attaches to a receiving element on the pan's body. This handle can be easily detached with one hand, enhancing safety and convenience during cooking. The handle can be detached during cooking, preventing it from getting hot and posing a burn risk to the user. It also allows for easy one-handed attachment and removal, even when the pan is hot. Further, if the cooking surface includes a lid, such as a barbecue grill, the removable handle ensures that the pan, once the handle is detached, can fit comfortably under a barbecue grill cover, facilitating closed-lid cooking. In further embodiments, the removable handle may interact with a lid to provide a mechanism to securely fasten or pivot the lid as needed.

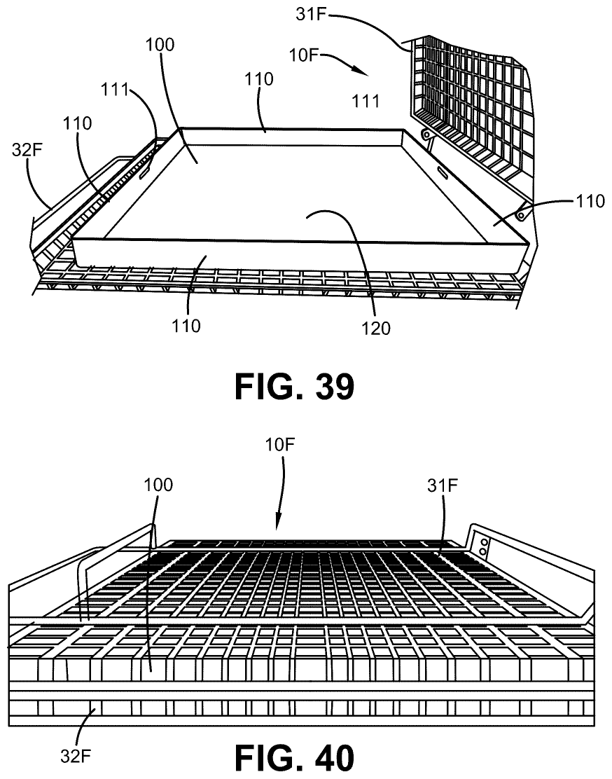

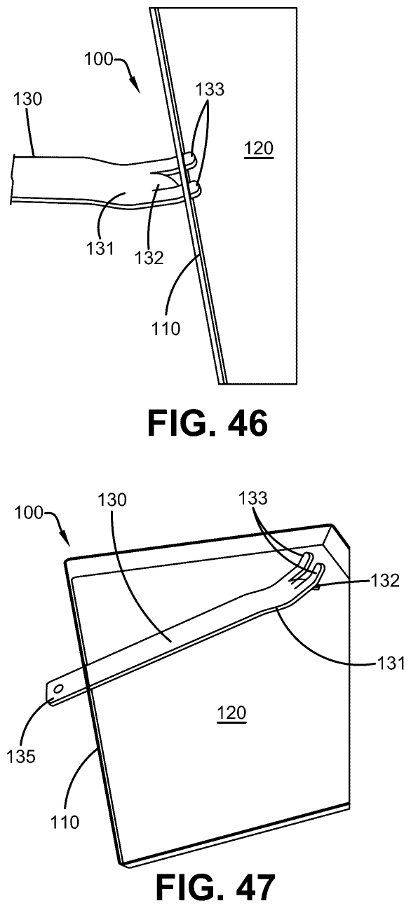

As shown in FIGS. 39-48, embodiments of the present invention provide grated food-handling device 10F including cooking utensil 100 with removable handle 130. Cooking utensil 100 may be generally understood as a pan including planar base 120, sidewalls 110, and handle slots in side walls 110. In other embodiments, the cooking utensil may have a single handle slot formed within at least one sidewall of the cooking utensil. In yet other embodiments, the cooking utensil may include an alternative handle connection means known in the art attached to the cooking utensil.

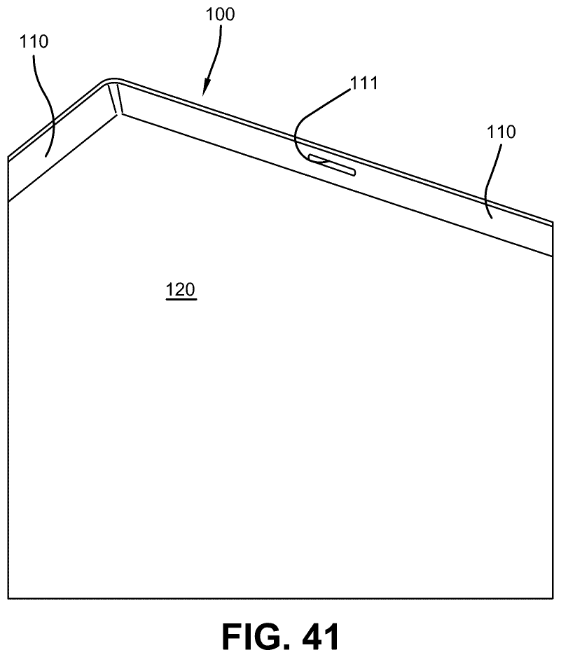

As shown in FIG. 41, cooking utensil 100 includes planar base 120 and sidewalls 110, including one handle slot 111 formed within one sidewall 110. Sidewalls 110 are substantially perpendicular to planar base 120. Planar base 120 provides a primary cooking surface of cooking utensil 100. Sidewalls 110 serve to prevent food, especially small food items, from sliding off of planar base 120.

Cooking utensils according to embodiments of the present invention may be constructed from a variety of suitable food safe materials known in the art. Examples of suitable food safe materials include stainless steel, carbon steel, cast iron, ceramics, and the like. Materials may be selected according to one or more heat tolerance, non-stick characteristics, durability concerns, weight, resistance to carbon build-up, heat retention, and heat transfer, amongst others.

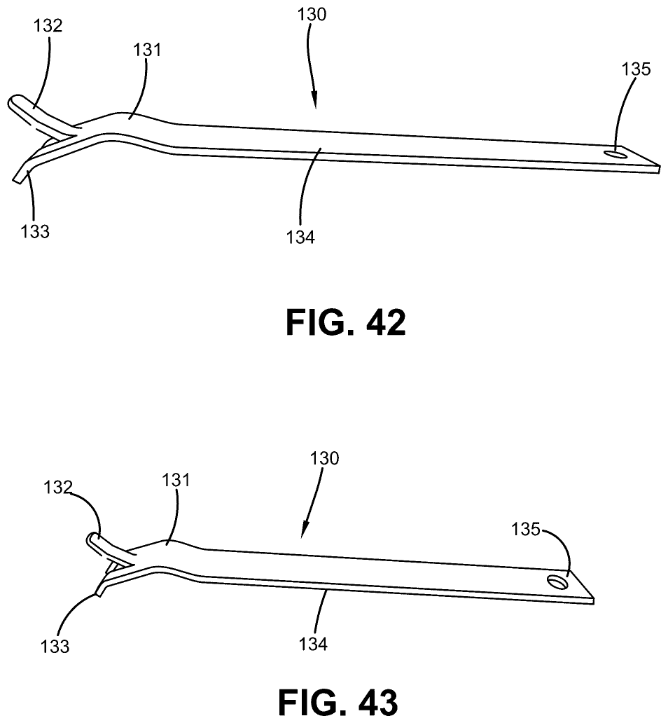

Removable handles according to embodiments of the present invention provide a means of engaging cooking utensils according to the present invention during cooking. Removable handles advantageously may be removed to allow for operation of grated food-handling devices according to the present invention as well as the other benefits described herein. As shown in FIGS. 42-43, removable handle 130 is shown. Removable hand 130 includes distal end 131 which includes support member 132 and engaging tines 133. Removable handle 130 further includes handle portion 134 and proximate end 135. Handle portion 134 and proximate end 135 are configured to be handled by a user when manipulating cooking utensil 100. Engaging tines 133 are configured to be received by handle slot 111 to removably attach removable handle 130 to cooking utensil 100. Support member 132 is configured to provide stability to the connection made by engaging tines 133 with cooking utensil 100. Removable handle 130 may be made of a single piece with distal end 131 having cut and bent portions to thereby form support member 132 and engaging tines 133.

Removable handles according to the present invention can be made from any suitable material including metal, ceramic, rubber, plastic, and combinations thereof, amongst others.

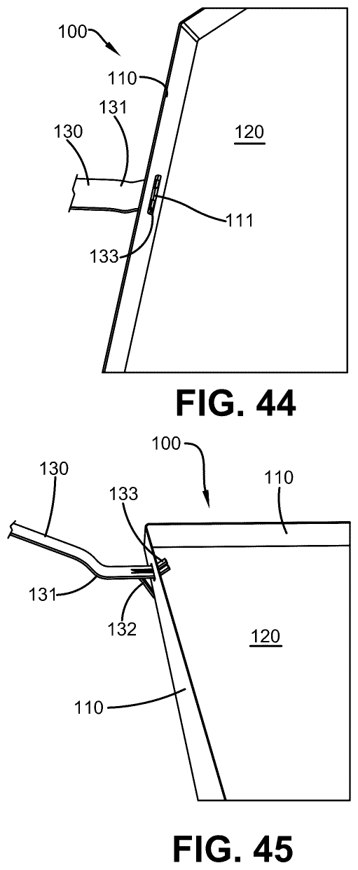

As shown in FIGS. 44-46, removable handle 130 is inserted into cooking utensil 100 via handle slot 111 receiving distal end 131 including engaging tines 133 and support member 132. Once inserted into cooking utensil 100, removable handle 130 may be used to lift and manipulate cooking utensil 100. Due to the quick and simple nature of engaging cooking utensil 100 with removable handle 130, cooking utensil 100 may be readily rotated with a grated food-handling device according to the present invention by lifting one of the first or second grated assembly, attaching removable handle 130 to cooking utensil 100, rotating cooking utensil 100, disengaging removable handle 130, utilizing another handle slot to accomplish further rotation if necessary and closing the first or second grated assembly.

In some embodiments, the handle slot might be slightly larger than the handle's distal end, allowing for easy insertion and some lateral movement.

In some embodiments, the angles between the handle's components and the cooking utensil are optimized for stability and to prevent accidental detachment while lifting the cooking utensil.

In some embodiments, the distal end of the handle may be inserted to the handle slot from the interior side of handle slot. In doing so, the cooking utensil may be easily lifted and rotated on the cooking surface or within a grated food-handling device according to the present invention. Specifically, by inserting the distal end of the handle from the interior, the center of the cooking utensil is aligned with the handle with balanced weight allowing for easy rotation of the cooking utensil on the cooking surface or within a grated food-handling device. Once rotation of the cooking utensil is complete, the removable handle is readily disengaged from the cooking utensil.

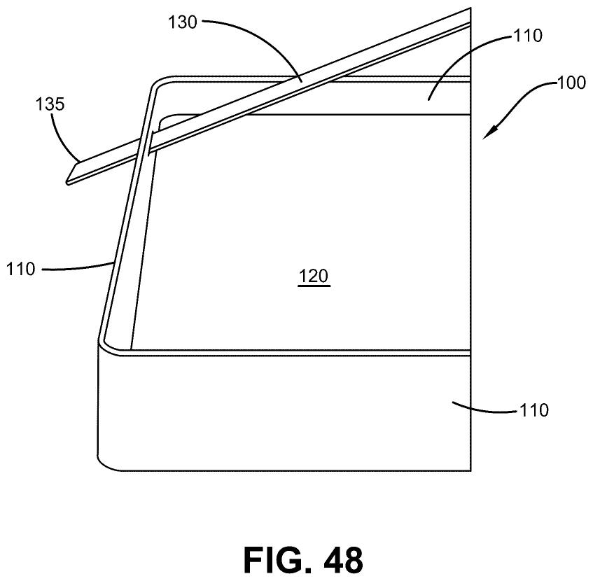

In some embodiments, the proximate end of the handle may be inserted to the handle slot from the interior side of handle slot. In doing so, when used with grated food-handling devices according to the present invention, the distal end of the handle may be used to hold either first grated assembly or second grated assembly in an open position to maintain access to the cooking utensil. As shown in FIGS. 47-48, proximate end 135 of handle 130 engages cooking utensil 100 via insertion into the handle slot formed in sidewall 110. Accordingly, when cooking utensil 100 is placed within the cooking volume of a grated food-handling device according to the present invention, the distal end (not shown), supports one of first grated assembly or second grated assembly such that access to planar base 120 is maintained to manipulate food cooking within cooking utensil 100.

A variety of cooking utensils may be suitable for use with a removable handle as described above. For example, the removable handle may be adapted for use on pots, pans, baskets, and the like. Further, the shapes of cooking utensils suitable for use in the present invention may be varied and include round, curved, square, rectangular, and other regular and irregular shapes.

Practice of the present invention is in no way limited to the cooking utensils and removable handles as shown in the drawings. Other cooking utensils and removable handles known in the art may be employed so long as they may fit within the cooking volume during use of grated food-handling devices according to the present invention. Such cooking utensils and removable handles may include any one of a number of cooking utensils and removable handles known in the art.

In light of the foregoing, it should be appreciated that the present invention significantly advances the art by providing a grated food-handling device that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A grated food-handling device having at least a closed configuration,
the grated food-handling device comprising:
a first grated assembly, the first grated assembly comprising:
a first support frame,
a first handle portion disposed at one end of the first support frame,
a first connecting portion disposed at an opposite end of the first support frame, and
a first planar grate disposed on the first support frame; and
a second grated assembly, the second grated assembly comprising:
a second support frame,
a second handle portion disposed at one end of the second support frame,
a second connecting portion disposed at an opposite end of the second support frame, and
a second planar grate disposed on the second support frame; and
wherein said first grated assembly and said second grated assembly are separably and movably connected to each other at the first and second connecting portion; and
where when the grated food-handling device is in the closed configuration a cooking volume is defined by the space between said first planar grate and said second planar grate.

2. The grated food-handling device of claim 1, wherein a perimeter portion of each of the first planar grate and the second planar grate is raised to partially enclose the cooking volume.

3. The grated food-handling device of claim 1, wherein the first handle portion extends beyond an area of the first planar grate, and wherein the second handle portion extends beyond an area of the second planar grate.

4. The grated food-handling device of claim 1, wherein each of the first support frame and the second support frame further comprise one or more standoffs.

5. The grated food-handling device of claim 4, wherein each of the first grated assembly and second grated assembly is a unitary construction.

6. The grated food-handling device of claim 1, wherein each of the first connection portion and the second connection portion include one or more hinge components.

7. The grated food-handling device of claim 6, wherein the first connection portion includes a first hinge component and a second hinge component, wherein the second connection portion includes a third hinge component and a fourth hinge component, and wherein the first hinge component removably engages the third hinge component and where in the second hinge component removably engages the fourth hinge component to thereby separably and movably connect the first grated assembly and the second grated assembly.

8. The grated food-handling device of claim 7, wherein the first and second hinge components each comprise:
an offset arm portion connected to the first support frame, and
an eyelet for receiving either the third hinge component or the fourth hinge component disposed at the end of the offset arm portion; and
wherein the third and fourth hinge components each comprise:
an offset arm portion connected to the second support frame, and
an engagement member for engaging either the first hinge component or the second hinge component disposed at the end of the offset arm portion.

9. The grated food-handling device of claim 7, wherein the engagement between the first and third hinge components and the engagement between the second and fourth hinge components is adjustable such that an internal height defined by the distance between the first planar grate and said second planar grate in the closed configuration is adjusted depending upon the engagement of the hinge components.

10. The grated food-handling device of claim 9, wherein the first and second hinge components each comprise:
an offset arm portion connected to the first support frame, and
a slotted eyelet including two or more slots for receiving either the third hinge component or the fourth hinge component disposed at the end of the offset arm portion; and
wherein the third and fourth hinge components each comprise:
an offset arm portion connected to the second support frame, and
an engagement member for engaging either the first hinge component or the second hinge component each via at least one of the two or more slots disposed at the end of the offset arm portion.

11. The grated food-handling device of claim 10, wherein one of the engagement members of the third and fourth hinge components is a secure hinge component further comprises a first perpendicular bend in a first plane, and a second perpendicular bend in a second plane perpendicular to the first plane.

12. The grated food-handling device of claim 11, wherein one of the slotted eyelets of the first and second hinge components and corresponding with the secure hinge component further comprises a retention guard to retain the secure hinge component in the closed configuration.

13. The grated food-handling device of claim 9, wherein the first and second hinge components each comprise:
an offset arm portion connected to the first support frame, and
a hinge body including two or more slotted eyelets; and
wherein the third and fourth hinge components each comprise:
an offset arm portion connected to the second support frame, and
a finger-operable spring-loaded pin for engaging either the first hinge component or the second hinge component each via at least one of the two or more eyelets.

14. The grated food-handling device of claim 9, wherein the first and second hinge components each comprise:
an offset arm portion connected to the first support frame, and
a hinge body including two or more eyelets; and
wherein the third and fourth hinge components each comprise:
an offset arm portion connected to the second support frame,
an engagement member for engaging either the first hinge component or the second hinge component each via at least one of the two or more eyelets disposed at the end of the offset arm portion, and
brace member connected to the offset arm portion and the engagement member.

15. The grated food-handling device of claim 14, wherein each of the engagement members of the third hinge component and the fourth hinge component are hand-deflectable for engaging and disengaging the first hinge component and the second hinge component.

16. The grated food-handling device of claim 14, wherein the engagement members of the third and fourth hinge components engage one of the two or more eyelets of the first hinge component and second hinge component from an outward facing side of the hinge body of the first hinge component and second hinge component.

17. A cooking utensil comprising:
a planar base, a plurality of sidewalls disposed along a perimeter of the planar base, at least one handle slot formed within at least one of the plurality of sidewalls, and a removable handle comprising a proximal end, a handle portion, and a distal end including one or more engaging tines and a stability member.

18. The cooking utensil of claim 17, wherein the distal end of the removable handle is insertable via the engaging tines into an interior side or an exterior side of each of the at least one handle slot formed within at least of the plurality of sidewalls, and wherein the stability member contacts the sidewall when the removable handle is inserted into the at least one handle slot.

19. A grated food-handling assembly comprising:
the grated food-handling device of claim 1;
a cooking utensil, the cooking utensil comprising:
a planar base, a plurality of sidewalls disposed along a perimeter of the planar base, at least one handle slot formed within at least one of the plurality of sidewalls, and a removable handle comprising a proximal end, a handle portion, and a distal end including one or more engaging tines and a stability member; and
wherein the cooking utensil is disposed within the cooking volume.

20. The grated food-handling assembly of claim 19, wherein the distal end of the removable handle is disposed in one of the at least one handle slots such that the stability member and one or more engaging tines contact the first grated assembly to thereby hold the first grated assembly in an open position to provide access to the cooking volume.
